(19) United States
(12) Patent Application Publication
(10) Pub. No.: US 2007/0288893 A1
(43) Pub. Date: Dec. 13, 2007

(54) EXTENDING CONFIGURATION SECTIONS IN CONFIGURATION

(75) Inventors: Daniel W. Roth, Bellevue, WA (US); John F. Noss, Issaquah, WA (US); Mark E. Gabarra, Woodinville, WA (US); Scott C. Seely, Bellevue, WA (US); Stephen J. Millet, Edmonds, WA (US); Travis J. Muhlestein, Redmond, WA (US); Vadim Meleshuk, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/422,967

(22) Filed: Jun. 8, 2006

(51) Int. Cl. G06F 9/44

(52) U.S. Cl. 717/120

(57) ABSTRACT

Extending managed code framework configurations. A data structure may be implemented in a computing system implementing a managed code framework. A computer readable medium includes a number of data fields stored on the medium and representing a data structure facilitating the extension of configuration parameters used in configuring class types instantiations of class types in the managed code framework. The data structure includes a first data field including data representing an extensions section. The extensions section includes elements including name/class type pairs, the name describing a tagged element in a mark-up document correlated with an application class type. The data structure also includes a second data field containing configuration elements for configuring class types for instantiating class types in a managed code framework. The second data field consumes one or more name/class type pairs from the first data field.

### BACKGROUND

### Background and Relevant Art

Computers and computing systems have affected nearly every aspect of modern living. Computers are generally involved in work, recreation, healthcare, transportation, entertainment, household management, etc. The functionality of computers is enabled through software products that enable the use of computer programming and data structures that allow for the storage and manipulation of data.

One advance that has been useful in facilitating the usefulness of computer systems is the use of programming frameworks that include various applications and tools that can enhance a user's experience when using a computer system. For example, one such framework is the .NET framework available from Microsoft Corporation of Redmond Washington. The .NET framework includes pieces that make up a Web Services managed code framework that allows applications to seamlessly integrate with network services. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated.

A framework typically includes a number of classes. Classes are template files that can be configured to create instances of an application that will be run within the framework. To configure the classes, configuration information is applied to the class. The configuration information is typically included in a configuration file such as a mark-up configuration document that is written for example in XML. However, in present systems, the configuration options are typically limited to what a framework application designer envisions at design time of the application. Thus, schema descriptions defining what acceptable configuration parameters may be varied in a configuration file are limited to the options specifically taken into account by the application designer; or framework designers when an external developer is creating their own framework to be consumed by other application developers.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In one embodiment, a data structure may be implemented in a computing system implementing a managed code framework. The computer readable medium includes a number of data fields stored on the medium and representing a data structure facilitating the extension of configuration parameters used in configuring class types instantiations of class types in the managed code framework. The data structure includes a first data field including data representing an extensions section. The extensions section includes elements including name/class type pairs, the name describing a tagged element in a mark-up document correlated with an application class type. The data structure also includes a second data field containing configuration elements for configuring class types for instantiating class types in a managed code framework. The second data field consumes one or more name/class type pairs from the first data field.

In another embodiment, a method for instantiating class types using extended configuration parameters in a computing system implementing a managed code framework is illustrated. The method includes reading configuration data from a first data structure. The configuration data references an extension name. This particular configuration data is not for natively configuring class types supplied with the managed code framework. The method further includes referencing a name/class type pair in second data structure. The name/class type pair is correlated with the extension name in the first data structure to discover a class type for deserializing the configuration data as defined in the name/class type pair. The class type in the name/class type pair is invoked to deserialize the configuration data.

Another embodiment is a method practiced in a computing system implementing a managed code framework. The method includes acts for extending configuration elements for class types not natively supplied in the managed code framework. The method includes defining in first data structure a name/class type pair. The name class type pair referres to a class type not natively supplied in the managed code framework but developed to be instantiated in the managed code framework. In a second data structure, configuration data is defined referring to the name/class type pair in the first data structure. The name/class type pair is correlated with the extension name in the first data structure for discovering the class type for deserializing the configuration data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a block diagram showing a configuration file and class types configured by configuration data in the configuration file; and

FIG. 2 illustrates a method of accessing extended configuration data.

### DETAILED DESCRIPTION

Embodiments herein may comprise a special purpose or general-purpose computer including various computer hardware, as discussed in greater detail below.

One embodiment described herein includes a configuration file that includes one or more extensions sections. The configuration file contains configuration parameters for configuring class type instances in managed code frameworks. The extensions sections are modifiable to include configuration data consumable by other configuration sections. For example, an extension section may include name/class type pairs, where the name may correlate to a class type that is able to deserialize configuration data in other configuration sections. Thus, configuration of a class type can be extended by extending an extensions section with name and class type configuration information consumable by other sections. The other sections can then be configured with configuration information, including configuration information applicable to the extended functionality.

As a specific example, suppose that a framework ships with class types that support bindings including basic HTTP and WS HTTP. However, a developer wishes to add support for UDP. The developer can develop a UDP class type and can add an element to an extensions section that correlates a name with a class type. For example, the element added to the extensions section may correlate the name “UDP” with a class type “UDP.” A different section can then have an element UDP that defines various configuration settings. The other section can consume the name/class type pair from the extensions section such that the UDP class type can be instantiated with the configuration information in the other section.

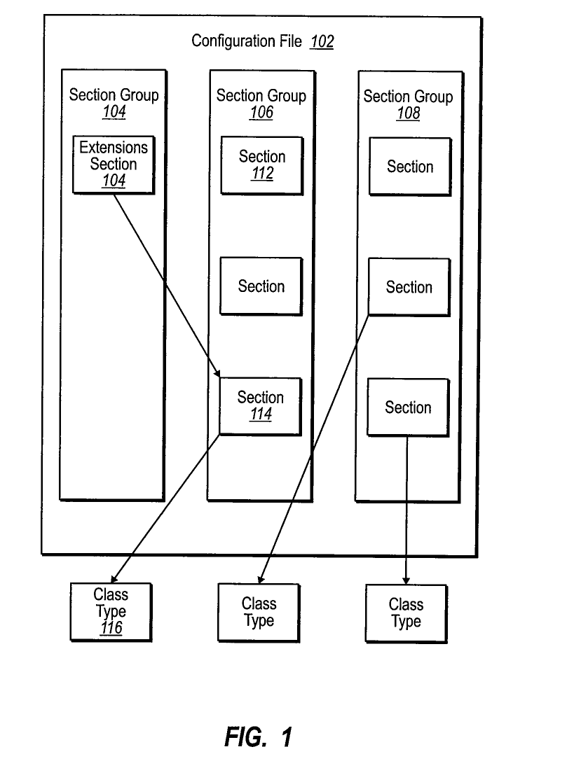

Referring now to FIG. 1, an exemplary configuration file 102 is illustrated. The configuration file 102 may include mark-up text such as for example, XML mark-up. Examples of mark-up will be illustrated further below. As shown in FIG. 1, the configuration file 102 may include a number of section groups 104, 106, 108. Section groups may be used to organize sections, described in more detail below, such that sections used for a common purpose are organized together. For example, one section group may be specific to sections for configuring display setting. Another section group may be specific to sections for configuring communication settings. Another section group may be specific to sections for diagnostic settings. Other groupings may also be implemented, and the three examples are in nowise exhaustive of the section groups that may be implemented. In particular, sections can be used to configure any configuration setting or state of a class when instantiating the class.

FIG. 1 further illustrates that each of the section groups include sections. The sections each include elements. Each element includes configuration data for configuring class types for instantiating a given class type. The elements may include configuration data for any configurable parameter for a given class type.

FIG. 1 illustrates that the section group 104 includes an extensions section 110. The extensions section 110 includes name class type pairs as described previously herein. These name class type pairs can be consumed by the other sections as will be explained in more detail below. The following is an XML example of a name class type pair in an extensions section of a configuration file.

```
<configuration>
  ...
  <system.serviceModel>
    ...
    <extensions>
      <behaviorExtensions>
        <add name=“MyExtension” type= “type”/>
      </ behaviorExtensions >
    </extensions>
  ...
  </system.serviceModel>
</configuration>
```

In this example the name of the name/class type pair is “MyExtention.” The type of the name/class type pair is “type.” By defining the element name and the type it links to in the extensions section, the entry of the element name and type is a well known element name in the configuration file 102. The element includes a discoverable class type name, which in one embodiment may be a fully qualified name. When the element is referenced elsewhere in the configuration file 102, an instance of the type linked to the name can be instantiated. Examples of this behavior follow herein.

The extensions section 110, in one embodiment includes a number of collections which include the elements in the extensions section 110. Each collection, may be specific to a given section group such that when extended tags are used in a section, the section can reference a specific collection of name/class type pairs corresponding to the particular section group to which the section belongs. For example, in the example above, the MyExtention extension is included in the behaviors collection. Other collections may exist including, but not limited to binding element extensions and binding extensions. In one embodiment, collections may correspond to a section group, such as the section group 106 or 108 illustrated in FIG. 1. In other embodiments, a collection may correspond to sections and/or elements.

Once a name class type pair has been added to the extensions section, custom extension elements can be used in the other sections. For example, as shown in FIG. 1, the section 112 may include an extended element making use of the name/class type pairs in the extensions section 110. The section 112 may consume data available in the extensions section 110.

The following xml code illustrates a simple configuration data structure which includes a section data structure within the configurations data structure which consumes extended name/class type pair elements in the extensions section data structure.

```
<configuration>
  <system.serviceModel>
    <extensions>
      <behaviorExtensions>
        <add name=“MyExtension” type= “type”/>
      </ behaviorExtensions >
    </extensions>
    <behaviors>
      <serviceBehaviors>
        <behavior name=“MyBehavior”>
          <MyExtension>
        </behavior>
      </serviceBehaviors>
    </ behaviors >
  </system.serviceModel>
</configuration>
```

As illustrated in FIG. 1, sections, such as section 114 may consume configuration data from the extensions section 110 when instantiating a class type 116. This allows the possible configuration elements in a section to be extended by including name/class type pairs in the extensions section 110 which indicate a type that is able to deserialize configuration data from the configuration section 114.

Notably, while in the examples illustrated herein, mark-up language such as XML has been used to define section elements including elements in the extensions sections, some elements may be defined by hard-coded instructions. For example, when the managed code framework ships, configuration parameters natively supported for definitions in the sections may use a similar process to that previously described herein. In particular, configuration that is natively supported may simply refer to default parameters natively included in the framework code. For example, if a configuration section includes configuration elements for a particular class type, hard-coded references may be used to invoke the class type to deserialize the configuration elements.

Notably, in some embodiments, the use of section groups allows for certain section groups to be extensible while other groups are fixed in scope. For example, in one embodiment, the section group 106 may be extensible such that configuration information in the extensions section 110 is consumable by sections in the section group. In contrast, the section group 108 may be fixed in scope such that all configuration information can only be defined within the original limits developed for the sections in the section group 108.

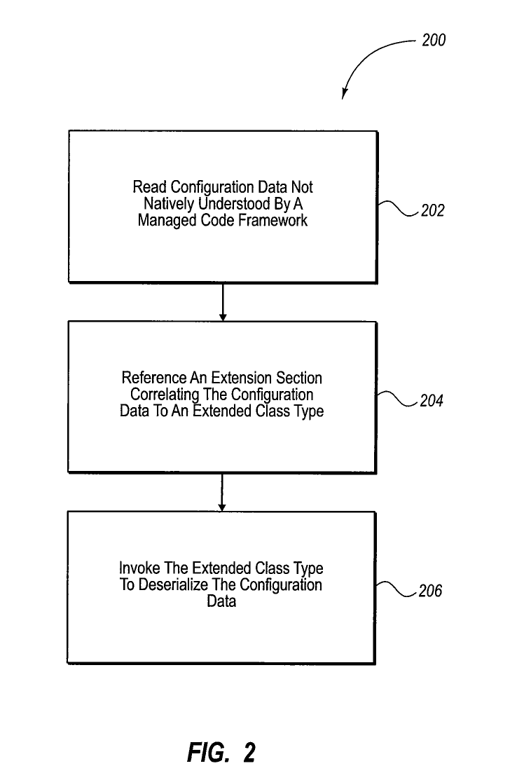

Referring now to FIG. 2, a method 200 of utilizing configuration parameters is illustrated. The method 200 includes an act of reading configuration data not natively understood by a managed code framework (act 202). For example, configuration data may be read from a section such as section 114 illustrated in FIG. 1. The configuration data in the section may refer to a class type which is not natively known by the managed code framework.

FIG. 2 further illustrates an act of referencing an extension section correlating the configuration data to an extended class type (act 204). For example, a developer may develop a class type for use with the managed code framework. Name/class type pairs for the newly developed or extended class type can be included in the extensions section 110 illustrated in figure one. Notably, the class type 116 may be the extended class type developed by a developer.

FIG. 2 further illustrates an act of invoking the extended class type to deserialize the configuration data (act 206). As illustrated in FIG. 1, the class type 116 can be invoked to deserialize configuration data in the section 114 where the extensions section 110 identifies the class type 116 as the appropriate class type for deserializing the configuration data in the section 114.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without a departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system implementing a managed code framework, a computer readable medium having a plurality of data fields stored on the medium and representing a data structure facilitating the extension of configuration parameters used in configuring class types instantiations of class types in the managed code framework, the data structure comprising:
a first data field including data representing an extensions section, wherein the extensions section includes elements comprising name/class type pairs, the name describing a tagged element in a mark-up document correlated with an application class type; and
a second data field containing configuration elements for configuring class types for instantiating class types in a managed code framework, wherein the second data field consumes one or more name/class type pairs from the first data field.

2. The computer readable medium of claim 1, wherein the extension section comprises a collection, the collection corresponding to the second data field.

3. The computer readable medium of claim 1, wherein the second data field comprises a configuration section.

4. The computer readable medium of claim 3, wherein the configuration section is contained in a section group which associates related sections.

5. The computer readable medium of claim 4, wherein the collection corresponds to the section group, wherein the section group serves as a container for related sections.

6. The computer readable medium of claim 4, wherein the collection groups extensions for at least one of behavior extensions, binding element extensions and binding extensions.

7. The computer readable medium of claim 1, wherein the data structure comprises mark-up language code.

8. The computer readable medium of claim 7, wherein the data structure comprises XML.

9. The computer readable medium of claim 1, wherein the data structure comprises hard coded elements included natively in the framework for default configuration settings.

10. The computer readable medium of claim 1, wherein the data structure comprises a configuration file organized by section groups, where each section group serves as a container for related sections.

11. In a computing system implementing a managed code framework, a method for instantiating class types using extended configuration parameters, the method comprising:
reading configuration data from a first data structure, the configuration data referencing an extension name, the configuration data not for natively configuring class types supplied with the managed code framework;
referencing a name/class type pair in second data structure, the name/class type pair correlated with the extension name in the first data structure to discover a class type for deserializing the configuration data as defined in the name/class type pair; and
invoking the class type in the name/class type pair to deserialize the configuration data.

12. The method of claim 11, wherein the second data structure comprises an extensions section containing name/class type pairs referencing class types that are extensions of the managed code framework.

13. The method of claim 11, wherein the class type is an extension of the managed code framework.

14. The method of claim 11, wherein the first data structure comprises a section contained in a section group, wherein the section group associates related sections

15. The method of claim 11, wherein the configuration data is for configuring at least one of behaviors, binding elements and bindings

16. The method of claim 11, wherein invoking the class type in the name/class type pair comprises configuring an instance of the class type.

17. In a computing system implementing a managed code framework, a method for extending configuration elements for class types not natively supplied in the managed code framework, the method comprising:
defining in first data structure a name/class type pair, the name class type pair referring to a class type not natively supplied in the managed code framework but developed to be instantiated in the managed code framework; and
defining in a second data structure, configuration data referring to the name/class type pair in the first data structure, the name/class type pair correlated with the extension name in the first data structure for discovering the class type for deserializing the configuration data.

18. The method of claim 17, further comprising extending the managed code framework by developing the class type not natively supplied in the managed code framework.

19. The method of claim 17, wherein the first data structure comprises an extensions section containing name/class type pairs referencing class types that are extensions of the managed code framework.

20. The method of claim 17, wherein the second data structure comprises a section contained in a section group, wherein the section group associates related sections.
